(19) United States
(12) Patent Application Publication
(10) Pub. No.: US 2012/0001824 A1
(43) Pub. Date: Jan. 5, 2012

(54) DISH ANTENNA

(76) Inventor: Wan-Ju YEH LIN, Hong kong (CN)

(21) Appl. No.: 12/828,296

(22) Filed: Jul. 1, 2010

(51) Int. Cl. H01Q 21/06

(52) U.S. Cl. 343/893

(57) ABSTRACT

A dish antenna is provided as an antenna arrangement that reduces overall size, occupies a small amount of space, and shows an effect of high gain. The dish antenna includes a dish portion, a metal plate, a bracket, a carrier, a stand, and a bottom board. The dish portion shows a curved configuration. The metal plate carries at least one antenna element mounted thereto in a rectangular array, or in a left-right symmetric form, or simply set at a central position. The antenna elements are connected to each other with transmission match lines to realize concentration and in-phase superimposition of electromagnetic waves and increase of transmitting/receiving power of antenna.

### TECHNICAL FIELD OF THE INVENTION

The present invention generally relates to a dish antenna, and more particularly to a dish antenna having a structure that increases transmitting and receiving power of antenna and provides a compact and high-gain configuration.

### DESCRIPTION OF THE PRIOR ART

Small-sized antennas that are available in the market are often a prime focus antenna or an offset antenna, and have a dish surface that is parabolic and has a focal point at which a low-noise block (LNB) converter is arranged to possess a good receiving position for amplifying signals. This arrangement forms a prominent projecting LNB at a center of the parabolic dish surface, making the appearance not beautiful. Further, such an antenna is often bulky in size and, for a high gain, the parabolic dish surface gets large and occupies a large amount of space. This is a major drawback of the antenna.

### SUMMARY OF THE INVENTION

The primary objective of the present invention is to provide a dish antenna, which relates to a compact high-gain array dish antenna.

Another objective of the present invention is to provide a dish antenna that overcomes the drawbacks of a conventional dish antenna of being bulky, showing a prominent projecting low noise block converter, occupying a large amount of space, and requiring increase of the size to accommodate change of gain by providing a dish antenna that is compact, occupies a less amount of space, and provides different gains by simply changing the number of antenna elements and thereby showing an economic advantage.

According to the present invention, a dish antenna is provided, comprising a dish portion, a metal plate, a bracket, a carrier, a bottom board, and a stand, wherein the dish portion shows a configuration of curved surface with no low-noise block converter or other devices set thereon.

According to the present invention, the dish antenna is structured so that the metal carries at least one antenna element mounted thereto at a central position. For a case of two antenna elements used, the antenna elements are arranged in a left-right symmetric form. For a case of four antenna elements used, the antenna elements are arranged in a rectangular array.

The antenna elements arranged in the dish antenna are arranged for in-phase superimposition and are provided with transmission lines that show impedance matching.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a dish antenna according to the present invention.

FIG. 2 is an exploded view of an embodiment of a dish antenna of the present invention applicable to a 15 dBi antenna.

FIG. 3 is an exploded view of an embodiment of a dish antenna of the present invention applicable to an 11 dBi antenna.

FIG. 4 is an exploded view of an embodiment of a dish antenna of the present invention applicable to a 9 dBi antenna.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

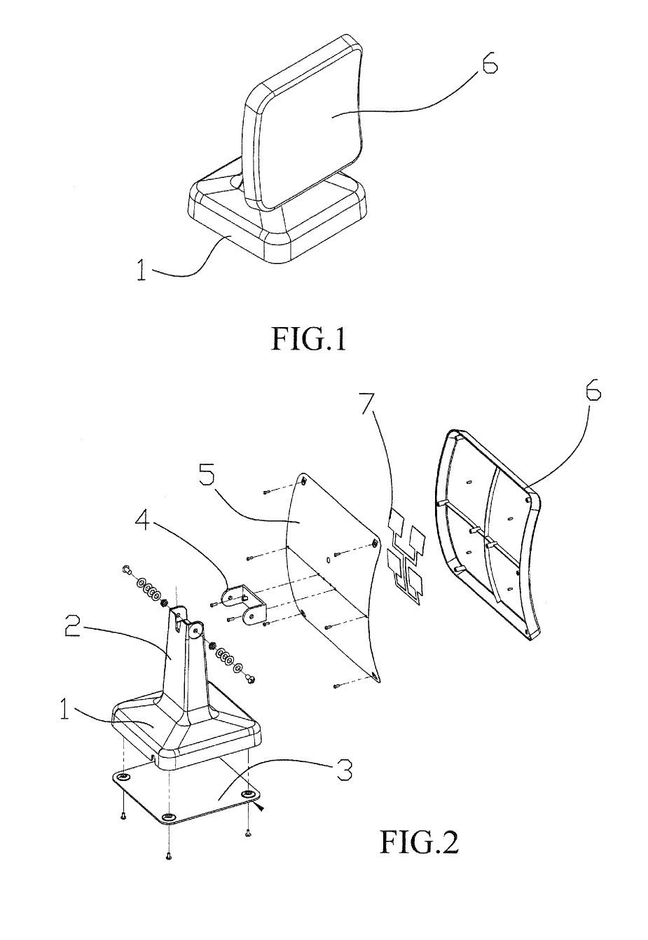

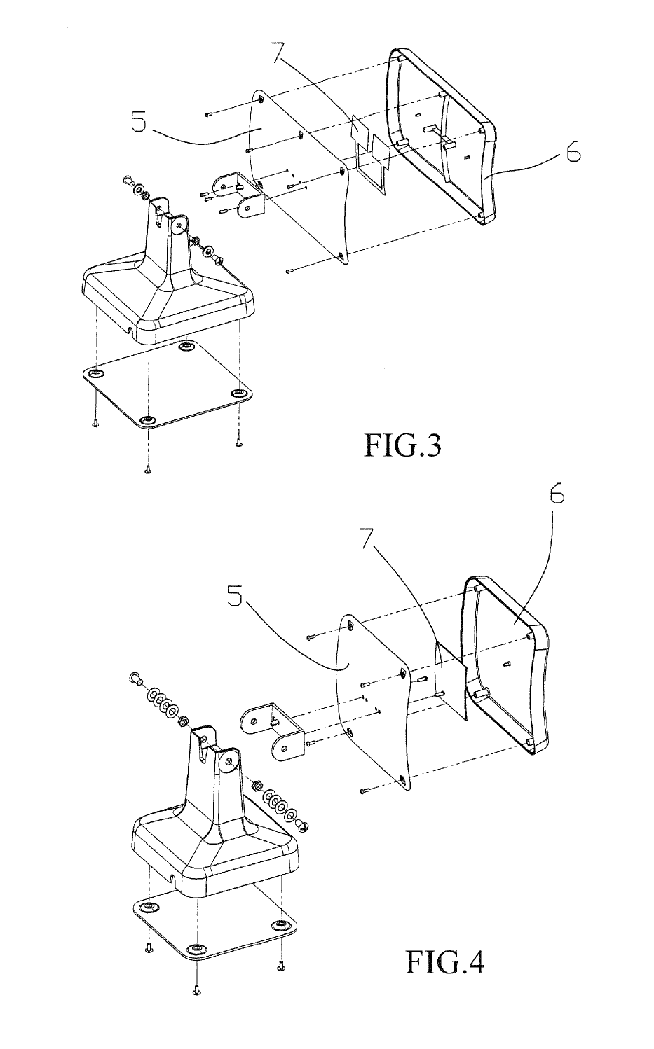

Embodiments of dish antenna according to the present invention will now be described with reference to the drawings. As shown in FIG. 1, the dish antenna comprises a dish portion 6 that is mounted to a stand or base 1. As shown in FIG. 2, a metal plate 5 is arranged inside the dish portion 6 and is mounted to the stand 1. The dish portion 6 shows a curved configuration. The metal plate 5 carries at least one antenna element 7 mounted thereto. The antenna element 7 is made of nickel silver to provide an excellent effect of high gain. Generally, a single antenna element 7 may show an effect for providing a power of at least 9 dBi. The number of the antenna element 7 can be increased or decreased according to the desired gain. Since the antenna element 7 provides a high gain and is made in a pillar form, it can effectively concentrate and superimpose electromagnetic waves to provide an optimum effect of high gain. As shown in FIG. 2, for a power of more than 15 dBi, four antenna elements 7 are used and arranged in a rectangular array. As shown in FIG. 3, for 11 dBi, two antenna elements 7 are used and arranged in a left-right symmetric form. As shown in FIG. 4, for 9 dBi, a single antenna element 7 is used and set at a central position. The antenna elements are connected to each other with transmission match lines to realize concentration and in-phase superimposition of electromagnetic waves and thus increasing transmitting/receiving power of antenna.

The antenna element 7 shows an effect of high gain in forward radiation and thus it provides excellent effect of isolation in other directions, such as backward direction. Consequently, noises in said other directions can be eliminated.

As shown in FIG. 2, a practical embodiment of the dish antenna according to the present invention is illustrated, in which the metal plate 5 is mounted to a carrier portion 2 of the stand 1 by a bracket 4. The stand 1 can be made of plastics and consequently, a metal bottom board 3 is combined with the stand 1 for well arranging the center of gravity.

In summary, the present invention provides a dish antenna, which is compact in size and thus occupies a small amount of space and which allows for varying gain by changing the number of antenna elements accommodated therein. Thus, the present invention shows an economic and practical effect.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A dish antenna comprising a dish portion that receives and retains therein a metal plate, the metal plate being mounted to a stand, and characterized in that the dish portion shows a curved configuration and the metal plate carries at least one antenna element mounted thereto.

2. The dish antenna according to claim 1, wherein the antenna element is made of nickel silver.

3. The dish antenna according to claim 1, wherein the metal plate carries four antenna elements that are arranged in a rectangular array.

4. The dish antenna according to claim 1, wherein the metal plate carries two antenna elements that are arranged in a left-right symmetric form.

5. The dish antenna according to claim 1, wherein the metal plate carries a single element that is set at a central position.

6. The dish antenna according to claim 3, wherein the antenna elements are connected to each other through transmission match lines.

7. The dish antenna according to claim 4, wherein the antenna elements are connected to each other through transmission match lines.
